(19) United States
(12) Patent Application Publication
(10) Pub. No.: US 2010/0210385 A1
(43) Pub. Date: Aug. 19, 2010

(54) TENSIONER ASSEMBLY FOR A ROTARY DRIVE

(75) Inventor: William C. Deneszczuk, Saline, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/371,650

(22) Filed: Feb. 16, 2009

(51) Int. Cl. F16H 7/12

(52) U.S. Cl. 474/135

(57) ABSTRACT

A tensioner assembly for an endless drive element is provided that utilizes rotary motion and damping with decoupled tensioning and damping components. The tensioner assembly includes a rotatable element in contact with a span of the drive element and rotatable via the drive element, and a first linkage supporting the rotatable element for rotation thereon. A torsion spring connects the first linkage for pivoting about a pivot point with respect to a base. The torsion spring is configured to bias the rotatable element in a direction to tension the drive element. A linear damper is operatively connected to the first linkage at a distance from the pivot point, such as by a second linkage or lever arm, and connected to the base for damping pivoting motion of the first linkage.

### TECHNICAL FIELD

The invention relates to a tensioner assembly, especially for a rotary accessory drive of an engine.

### BACKGROUND OF THE INVENTION

Belt drive systems are used to operate ancillary components associated with automotive engines. For example, belt drive systems are used to drive complex valve trains, balance shafts, oil pumps, high pressure fuel injection pumps and water pumps. A dedicated tensioning system is used to ensure the overall functional performance of a belt drive system given the advent of increasing packaging complexity and its influence on belt drive layout and design. A typical tensioning system includes a belt drive tensioner and a tensioner arm that engages a belt along an engagement length to create an initial required tension on the belt.

Over time, as the belt of the belt drive system wears, slack is generated. As the belt wears, it is the tensioner system that is operable to remove the slack from the system. Often, a relatively long belt is necessary, requiring a tensioning system that can control the greater potential variation in belt tightness in a long belt. One type of tensioner system is a wound coil spring with an internal friction damper operable to damp rotary motion. Another type of tensioner system is a linear coil system concentric with a hydraulic damper. In both of these types of tensioner systems, the tensioning spring operates over the same range of motion, whether rotary or linear, as the damper.

In a belt-alternator starter-type hybrid powertrain with a rotary belt drive system, a motor/generator may be controlled to start the engine by driving the engine crankshaft via the belt. The belt may be subjected to large dynamic forces. The tensioner system must adequately dampen these forces while tensioning the relatively long belt.

### SUMMARY OF THE INVENTION

A tensioner assembly for an endless drive element is provided that utilizes rotary motion and linear damping with decoupled tensioning and damping components. The drive element may be a belt or chain. The tensioner assembly includes a rotatable element in contact with a span of the drive element and rotatable via the drive element, and a first linkage supporting the rotatable element for rotation thereon. The rotatable element may be a pulley, a sprocket or a gear. A torsion spring operatively connects the first linkage to a base for pivoting about a pivot point with respect to the base. The torsion spring is configured to bias the rotatable element in a direction to tension the drive element. A linear damper is operatively connected to the first linkage at a distance from the pivot point, such as by a second linkage or lever arm, and is grounded to the base for damping pivoting motion of the first linkage. Thus, the torsion spring and the damper are decoupled from one another and are able to operate over different ranges of motion. A range in flexibility of the tensioning function is achieved by selecting a spring force appropriate for expected operating parameters, and by selecting the length of the lever arm to maintain a relatively short damper travel range, without compromising system damping. High damping capability is provided with a relatively short damper travel range by utilizing the mechanical advantage of the lever arm. The damping element is not burdened with the structure needed to retain and retract a linear spring, as is typical for spring tensioners. The length of the damping element is not constrained by spring wire diameter, and it is therefore potentially shorter with a smaller packaging envelope. The tensioner assembly has greater flexibility in mounting and orientation within available packaging space on an engine assembly.

The tensioner assembly may be part of a rotary accessory drive for a powertrain with an engine and a motor/generator that is used to start the engine. For example, the drive element may be a belt in contact with the rotatable element, which may be a tensioner pulley, and in contact with a motor/generator pulley, and a crankshaft pulley. The tensioner assembly tensions the belt and dampens dynamic loading on the belt when the motor/generator is used to start the engine via the drive belt.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic front view of an engine with a rotary accessory drive system and a tensioner assembly acting thereon;

FIG. 2 is a schematic front view of the tensioner assembly of FIG. 1, rotated with respect to the position shown in FIG. 1; and

FIG. 3 is a schematic partial cross-sectional view of the tensioner assembly of FIGS. 1 and 2, taken at the arrows shown in FIG. 2 and showing the torsion spring of the tensioner assembly encircling the cross-sectional portion.

### DESCRIPTION OF THE PREFERRED EMBODIMENTS

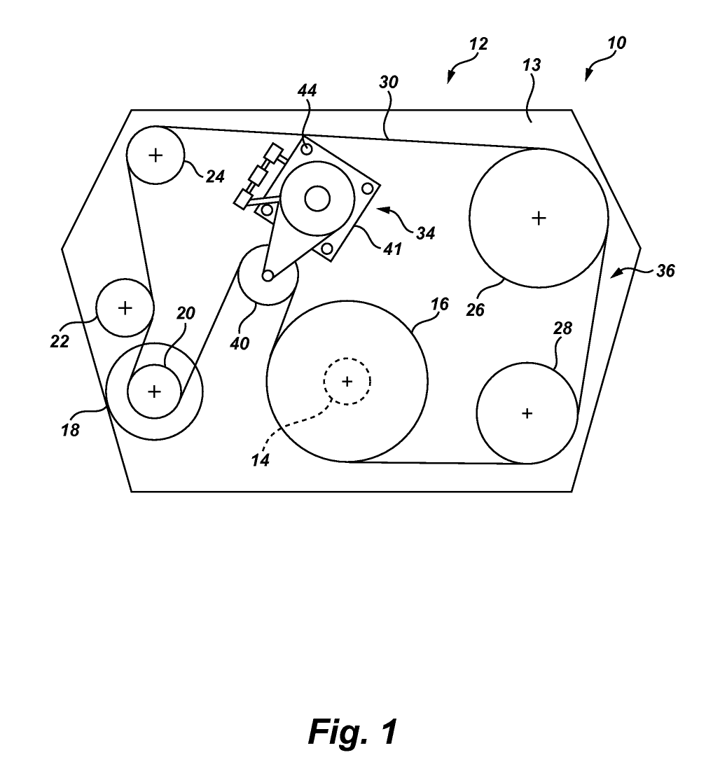

Referring to the drawings, wherein like reference numbers refer to like components throughout the several views, FIG. 1 shows a portion of a powertrain 10 including an engine 12 with an engine block 13 supporting a crankshaft 14 with a crankshaft pulley 16 mounted thereon. A motor/generator 18, represented by a motor shaft that supports a motor/generator pulley 20 is mounted to the engine 12. Various additional pulleys 22, 24, 26, 28 for accessories and other engine-driven components are also supported on the engine 12. A drive belt 30 interconnects all of the pulleys 16, 20, 22, 24, 26 and 28 so that the crankshaft 14 drives the accessories when the engine 12 is running. Additionally, the motor/generator 18 may be operated as a motor to turn the crankshaft 14 via the interconnected pulleys 20, 16 and drive belt 30 in order to start the engine 12, such as in a cold start or a restart in a hybrid operating mode. Efficient operation of the drive belt 30 to carry out the distribution of drive force to the various pulleys 20, 22, 24, 26 and 28 is maintained with a tensioner assembly 34 operable to maintain appropriate levels of belt tension and to dampen variations in belt tension, as described below. The interconnected pulleys 16, 20, 22, 24, 26, 28, drive belt 30 and tensioner assembly 34 establish an efficient rotary accessory drive 36, with the tensioner assembly 34 maintaining appropriate belt tension and damping via a tensioner pulley 40 in contact with a span of the drive belt 30.

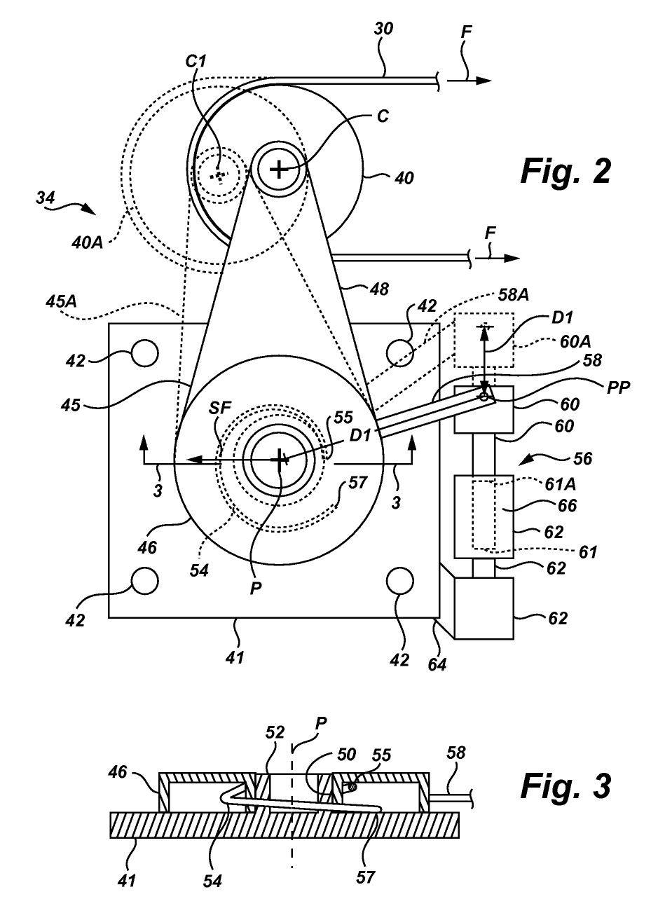

Referring to FIGS. 2 and 3, the tensioner assembly 34 is shown in greater detail, and in a different orientation than shown in FIG. 1. The tensioner assembly 34 includes a base 41, which may be generally plate-like, and has apertures 42 that align with openings or bores in the engine block 13 (not shown) or other structure (e.g., front cover or bracket, etc.) so that the base 41 mounts to the engine with bolts 44 or other attachment devices, as shown in FIG. 1.

Referring to FIG. 2, the tensioner assembly 34 further includes a first linkage 45 with a body portion 46 and a pivot arm 48 extending therefrom. The pivot arm 48 may have raised strengthening ribs or other structural features (not shown). The tensioner pulley 40 mounts to a distal portion of the pivot arm 48 so that the tensioner pulley 40 is free to rotate with respect to the pivot arm 48 via the drive belt 30 about a center axis extending into the Figure and represented by center C. Referring to FIG. 3, the body portion 46 has an annular opening 50 that is configured to mount to an annular extension 52 of the base 41 so that first linkage 45 is free to pivot about a pivot axis P extending into FIG. 2 and shown lengthwise in FIG. 3.

The tensioner assembly 34 has a tensioning component in the form of a torsion spring 54 and a damping component in the form of a linear damper or strut 56 that is remote from the torsion spring 54. The linear damper 56 is shown as a hydraulic damper, but could alternatively be a locking-type damper. Separating the tensioning component (i.e., spring 54) from the damping component (i.e., damper 56) as described herein increases packaging flexibility and permits the hydraulic damper 56 to be reduced in size.

The torsion spring 54 is wound concentric with the pivot axis P and has a first end portion 55 secured to the body portion 46 and a second end portion 57 secured to the base 41. Although a wound spring 54 is shown, a torsion bar-type rotary spring may also be used. The torsion spring 54 is wound to exhibit a spring force SF that resists dynamic belt forces on the tensioner pulley 40, represented by belt forces F, that are applied to the spring 54 via the first linkage 45. Unlike typical torsion spring tensioner assemblies, there is no damping element positioned between the body portion 46 and the base 41 operable to resist relative motion of the body portion 46 and base 41. Instead, damping is provided by a linear hydraulic damper 56 that is connected with the body portion via a link arm 58, also referred to as a lever arm or a second linkage. The link arm 58 is angularly spaced from center axis C of the pulley 40 about the pivot axis P. The link arm 58 is pivotably attached to a first portion 60 of the damper 56 at a pivot point PP. Thus, the damper 56 is spaced a distance D from the pivot point P. A second portion 62 of the damper 56 is fixed to the base 41 via third linkage 64, and is thus grounded to the engine casing 13 of FIG. 1 when the base 41 is mounted thereon. Hydraulic fluid, which may be a liquid or a gas, such as air, fills a cavity between the first portion 60 and the second portion 62.

When the first linkage 45 is urged to pivot about pivot axis P due to belt forces F that overcome the torsion spring force SF, causing the first linkage 45 to pivot from a first position shown in phantom as 45A to a second position shown in solid in FIG. 2, with the entire tensioner pulley 40 moving from a first position 40A to the position shown in FIG. 2. The link arm 58 rotates with the pivoting first linkage 45 from a first position 58A to the position shown in FIG. 2. This causes the first portion 60 of the damper 56 to translate from the first position indicated in phantom as 60A to the position shown in FIG. 2. An end 61 of the first portion 60 travels from the position indicated at 61A to the position indicated at 61. The first portion 60 thus moves relative to the second portion 62, with hydraulic fluid within the cavity 66 damping the motion. By removing the tensioning function from the hydraulic damper 56, and instead utilizing a remote torsion spring 54 to provide tensioning, the overall diameter of the damper 56 may be smaller. Additionally, a travel distance D1 of the first portion 60A (i.e., between the position of pivot point PP when the damper moves from the first position 60A to the second position indicated as 60 is influenced by the overall distance D and the spring constant of spring 54. The length of the link arm 58, and the overall distance D of which the length of link arm 58 is a portion, creates a mechanical advantage for the damper force to damp motion of the link 45.

While the best modes for carrying out the invention have been described in detail, those familiar with the art to which this invention relates will recognize various alternative designs and embodiments for practicing the invention within the scope of the appended claims.

1. A tensioner assembly for an endless drive element comprising:
a rotatable element in contact with a span of the drive element and rotatable via the drive element;
a first linkage supporting the rotatable element for rotation thereon;
a base;
a torsion spring connecting the first linkage for pivoting about a pivot point with respect to a base and configured to bias the rotatable element in a direction to tension the drive element; and
a linear damper operatively connected to the first linkage at a distance from the pivot point and connected to the base for damping pivoting motion of the first linkage.

2. The tensioner assembly of claim 1, further comprising:
a second linkage extending from the first linkage at an angular spacing from the rotatable element; wherein the linear damper is connected to the second linkage.

3. The tensioner assembly of claim 2, wherein the linear damper has a first portion connected to the second linkage and a second portion grounded to the base; and wherein linear travel of the damper is a function of spring rate of the torsion spring and the distance of the second linkage from the pivot point to the first portion of the damper.

4. The tensioner assembly of claim 3, further comprising:
a third linkage connecting the base to the second portion of the linear damper.

5. The tensioner assembly of claim 1 in combination with an engine and a motor/generator, and wherein the drive element operatively connects the motor/generator to the engine for starting the engine.

6. The tensioner assembly of claim 5, wherein the base has apertures configured to align with openings in the engine for mounting the tensioner assembly to the engine.

7. A tensioner assembly for an endless drive element comprising:
a base;
a pivot arm having a pivot axis through the base;
a first rotatable element in contact with a span of the drive element and secured to the pivot arm remote from the pivot axis and rotatable about a center axis via the drive element;
a torsion spring connecting the pivot arm to the base and configured with a spring force urging the pivot arm to resist pivoting due to a drive force on the first rotatable element;
a link arm extending from the pivot arm; and
a hydraulic damper having a first portion fixed to the link arm, a second portion fixed to the base, and hydraulic fluid damping relative movement of the first portion and the second portion.

8. The tensioner assembly of claim 7, wherein the hydraulic tensioner is characterized by the absence of a linear spring.

9. A rotary accessory drive for a powertrain including an engine and a motor/generator, comprising:
a crankshaft pulley, a motor/generator pulley, and a tensioner pulley;
an endless drive belt in contact with the pulleys;
a pivot arm supporting the pulley for rotation thereon;
a torsion spring connecting the pivot arm for pivoting about a pivot point with respect to the engine and configured to bias the pulley in a direction to tension the drive belt;
a link extending from the pivot arm; and
a linear hydraulic strut operatively connected to the link at a distance from the pivot point and operatively grounded to the engine for damping dynamic loading on the belt when the motor/generator is used to start the engine via the drive belt interconnecting the pulleys.

10. The rotary accessory drive of claim 9, further comprising:
a base mounted to the engine; wherein one end of the torsion spring is grounded to the base; and wherein the hydraulic strut is grounded to the engine via the base.
